(19) United States
(12) Patent Application Publication
(10) Pub. No.: US 2024/0208076 A1
(43) Pub. Date: Jun. 27, 2024

(54) VARIABLE COMPLIANCE FINGER ASSEMBLY

(71) Applicant: Ocado Innovation Limited, Hatfield, Hertfordshire (GB)

(72) Inventors: Jan FRAS, Hatfield, Hertfordshire (GB); Panagiotis SOTIROPOULOS, Hatfield, Hertfordshire (GB); Hussein MNYUSIWALLA, Hatfield, Hertfordshire (GB); Enrique DEL SOL ACERO, Hatfield, Hertfordshire (GB); Pavlos TRIANTAFYLLOU, Hatfield, Hertfordshire (GB)

(73) Assignee: Ocado Innovation Limited, Hatfield, Hertfordshire (GB)

(21) Appl. No.: 18/553,298

(22) PCT Filed: Mar. 31, 2022
(86) PCT No.: PCT/EP2022/058665

§ 371 Date: Sep. 29, 2023

(30) Foreign Application Priority Data
Mar. 31, 2021 (GB) 2104612.3

(51) Int. Cl. B25J 15/00; B25J 9/14; B25J 15/02

(52) U.S. Cl. CPC B25J 15/0023; B25J 9/142; B25J 15/0253

(57) ABSTRACT

This disclosure relates to a manipulating apparatus including a finger assembly with a rigid body having an aperture and an inflatable element received within the rigid body. When the inflatable element is inflated, a region of the inflatable element forms a protrusion through the aperture. A controller is configured to output an inflation control signal for pressurising the inflatable element according a target pressure, the target pressure being dependent on a characteristic of an object being manipulated.

This present disclosure relates generally to the field of finger assemblies for a manipulating apparatus, and more specifically to finger assemblies that having a gripping surface with a variable compliance.

### BACKGROUND

Automated picking systems require robotic picking stations which are able to select an item from a first receptacle, such as a tote or other storage unit, grip the item, and then move the item into a second receptacle, such as a bag. When manipulating items, it is beneficial for one or more parts of the finger assemblies of the manipulating apparatus to have a variable compliance so that robust or fragile items can be grasped without risk of damage.

It is against this background that the invention has been devised.

### SUMMARY

Accordingly, in a first aspect, the invention provides a manipulating apparatus comprising a finger assembly comprising a rigid body having a surface configured to engage an object, the surface comprising one or more apertures; and, an inflatable element received within the rigid body, wherein when the inflatable element is inflated, regions of the inflatable element form one or more protrusions by protruding through the one or more apertures; a controller configured to output an inflation control signal for pressurising the inflatable element according a target pressure, the target pressure being dependent on a characteristic of the object; and, a pressure regulating means configured to receive the inflation control signal and pressurise the inflatable element in dependence on the inflation control signal.

Preferably, the controller is configured to vary the pressure within the inflatable element within the range of 1 to 5 bar.

Preferably, the surface configured to engage an object has a first coefficient of friction and the surface of the inflatable element has a second coefficient of friction and wherein the first coefficient of friction is less than the second coefficient of friction.

A mesh may be formed on a surface of the inflatable element. The mesh may be formed on the surface of the inflatable element which forms the one or more protrusions. The application of the mesh may increase the stability of the protrusions when the inflatable element is inflated and increase the physical durability and resilience of the inflatable element.

The rigid body may comprise a rear surface which is in opposition to the surface configured to engage an object and one or more reinforcement elements which connect the rear surface to the surface configured to engage an object. The reinforcement elements increase the rigidity of the finger assembly and reduce the risk that the inflation of the inflatable element leads to the finger assembly becoming distorted, for example by causing the gripping surface to bend.

At least one of the one or more apertures is substantially circular. Alternatively, at least one of the one or more apertures may be substantially elongate. Alternatively, in embodiments comprising a plurality of apertures, one of the plurality of apertures may be substantially circular, whereas another of the plurality of apertures may be substantially elongate. Alternatively, the finger assembly may comprise apertures of different shapes and/or sizes.

The manipulating apparatus may comprise an actuator which, in use, can be activated to move the finger assembly. The actuator may move the finger assembly in multiple axes of movement and may be used to rotate the actuator about multiple axes of rotation. The controller is configured to output an actuation control signal causing the finger assembly to move, and wherein the actuator is configured to receive the actuation control signal and move the finger assembly in dependence on the actuation control signal.

The controller may cause the inflatable element of the finger assembly to be inflated in accordance with the location of the finger assembly relative to the object. The controller may cause the inflatable element to be inflated when the finger assembly is moved into proximity with the object. Alternatively, the controller may cause the inflatable element of the finger assembly to be inflated when the finger assembly is moved into contact with the object.

In a second aspect, there is provided a method of manipulating an object using a manipulating apparatus according to the first aspect, the method comprising the steps of moving a first finger assembly relative to a second finger assembly to engage the object; inflating the inflatable elements of the first and second finger assemblies; determine a target pressure within the inflatable elements according to a characteristic of the object; varying the pressure within the inflatable elements according to the target pressure; engaging the object with the first and second finger assemblies; and, manipulating the object.

Preferably, the method further comprises the steps of deflating the inflatable elements of the first and second finger assemblies; and, disengaging the first and second finger assemblies from the object.

### BRIEF DESCRIPTION OF THE DRAWINGS

These and other aspects of the invention will now be described by way of example only with reference to the accompanying drawings, in which:

FIG. 1 shows a schematic depiction of a manipulating apparatus according to an embodiment of the invention;

FIG. 2 shows a schematic depiction of an embodiment of a finger assembly for use in the manipulating apparatus of FIG. 1;

FIG. 3 shows a schematic depiction of a gripping surface of the finger assembly of FIG. 2;

FIG. 4 shows a schematic depiction of an inflatable element of the finger assembly of FIG. 2;

FIG. 5 shows a schematic depiction of a cross-section of the finger assembly of FIG. 2 parallel to the gripping surface;

FIGS. 6 to 8 show schematic depictions of a cross-section of the finger assembly of FIG. 2 orthogonal to the gripping surface;

FIGS. 9 and 10 show a schematic side view of the finger assembly of FIG. 2;

FIG. 11 is a schematic view of the finger assembly of FIG. 2 with the inflatable element engaged with an object when the pressure within the inflatable element is high;

FIG. 12 is a schematic view of the finger assembly of FIG. 2 with the inflatable element engaged with an object when the pressure within the inflatable element is comparatively lower;

FIG. 13 shows a schematic depiction of a cross-section of an alternative embodiment of a finger assembly for use in the manipulating apparatus of FIG. 1 parallel to the gripping surface;

FIG. 14 shows a schematic depiction of an inflatable element of the finger assembly of FIG. 13;

FIG. 15 shows a schematic depiction of a gripping surface of the finger assembly of FIG. 13; and,

FIG. 16 shows a schematic side view of the finger assembly of FIG. 13.

In the drawings, like features are denoted by like reference signs where appropriate.

### DETAILED DESCRIPTION

In the following description, some specific details are included to provide a thorough understanding of the disclosed examples. One skilled in the relevant art, however, will recognise that other examples may be practiced without one or more of these specific details, or with other components, materials, etc., and structural changes may be made without departing from the scope of the invention as defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.” Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise.

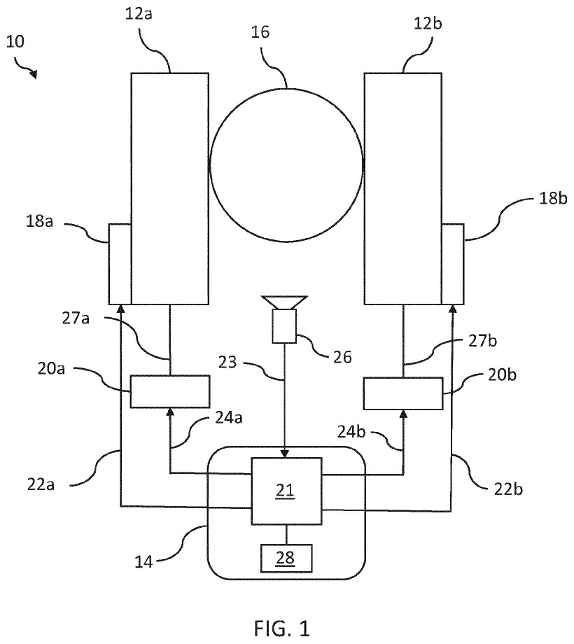

FIG. 1 shows a schematic depiction of a manipulating apparatus 10 according to an embodiment of the invention comprising a first finger assembly 12a opposing a second finger assembly 12b, and a controller 14. Each one of the first and second finger assemblies 12a, 12b includes an inflatable element (not shown in FIG. 1), an exterior surface of which comprises a gripping surface arranged to grip an object 16 to be manipulated. The manipulating apparatus 10 further comprises a first actuator 18a and a first pressure regulating means 20a, both of which are associated with the first finger assembly 12a, and a second actuator 18b and a second pressure regulating means 20b associated with the second finger assembly 12b. The first and second pressure regulating means 20a, 20b are connected to their associated finger assembly 12a, 12b by respective pressure lines 27a, 27b and other suitable connectors. The controller 14 comprises an electronic processor 21 having one or more electrical inputs for receiving an input signal, such as, for example, a visual data input signal 23 from an optical sensor 26 that forms part of the manipulating apparatus 10, and one or more electrical outputs for outputting one or more control signals 22a, 22b, 24a, 24b to the first and second actuators and pressure regulating means 18a, 18b, 20a, 20b in dependence on the visual data input signal 23. For example, the controller 14 is configured to output a first actuation control signal 22a for moving the first finger assembly 12a based on the visual data input signal 23. The first actuator 18a is configured to receive the first actuation control signal 22a and move the first finger assembly 12a relative to the second finger assembly 12b in dependence on the first actuation control signal 22a. Similarly, the controller 14 may also output a second actuation control signal 22b for moving the second finger assembly 12b based on the visual data input signal 23. The second actuator 18b is configured to receive the second actuation control signal 22b and move the second finger assembly 12b relative to the first finger assembly 12a in dependence on the second actuation control signal 22b. These movements may be about multiple axes of movement and include rotation of one of the first or second finger assembly 12a, 12b relative to the other of the first or second finger assembly 12a, 12b. Such movement may allow the object 16 to be gripped between the first and second finger assemblies 12a, 12b. The first and second finger assemblies 12a, 12b may also be movable together such that the object 16 gripped therebetween can be moved from a first location to a second location. The controller 14 is further configured to output inflation control signals 24a, 24b, in dependence on the visual data input signal 23, to control the first or second pressure regulating means 20a, 20b in order to alter the pressure in the interior of the first or second finger elements 12a, 12b so as to change the compliance of their respective inflatable element. Specifically, the controller 14 is arranged to output a first inflation control signal 24a based on the visual data input signal 23, and the first pressure regulating means 20a is configured to receive the first inflation control signal 24a and pressurise the first finger assembly 12a in dependence on the first inflation control signal 24a. Similarly, the controller 14 is arranged to output a second inflation control signal 24b based on the visual data input signal 23, and the second pressure regulating means 20b is configured to receive the second inflation control signal 24b and pressurise the second finger assembly 12b in dependence on the second inflation control signal 24b in order to alter the compliance of its inflatable element. In order to generate the control signals 22a, 22b, 24a, 24b, the controller 14 further comprises a memory device 28 electrically coupled to the electronic processor 21 and having instructions stored therein. The electronic processor 21 is configured to access the memory device 28 and execute the instructions stored thereon so as to carry out the foregoing processes.

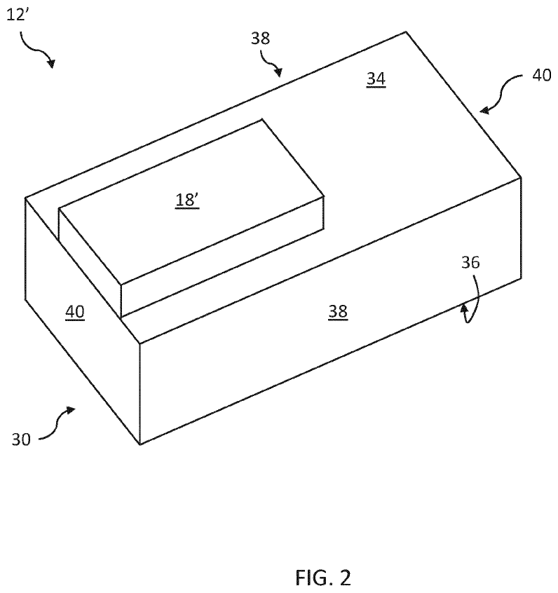

FIGS. 2 to 10 show schematic depictions of a finger assembly 12′ according to an embodiment of the invention, which is suitable for use in the manipulating apparatus 10. The finger assembly 12′ comprises a rigid body 30 in which is received an inflatable element 32.

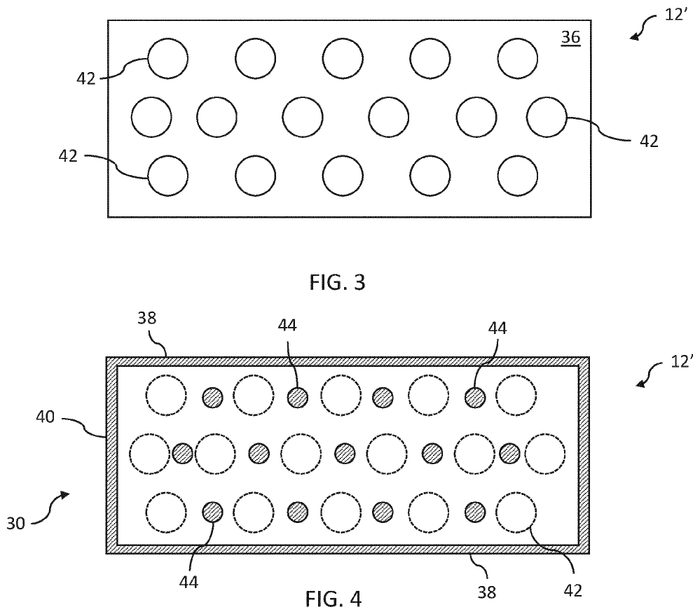

Referring to FIG. 2, which is a perspective view of a schematic depiction of the finger assembly 12′, the rigid body 30 is substantially cuboidal and comprises a rear surface 34 on which an actuator 18′ is received. The rigid body 30 further comprises a gripping surface 36 (not shown in FIG. 2) which is opposed to the rear surface 34. The gripping surface 36 is configured to engage an object 16 to be manipulated and is connected to the rear surface 34 by two side faces 38 and two end faces 40. FIG. 3 shows a view of the gripping surface 36 comprising one or more apertures 42. In this embodiment, the gripping surface 36 comprises a plurality of apertures 42.

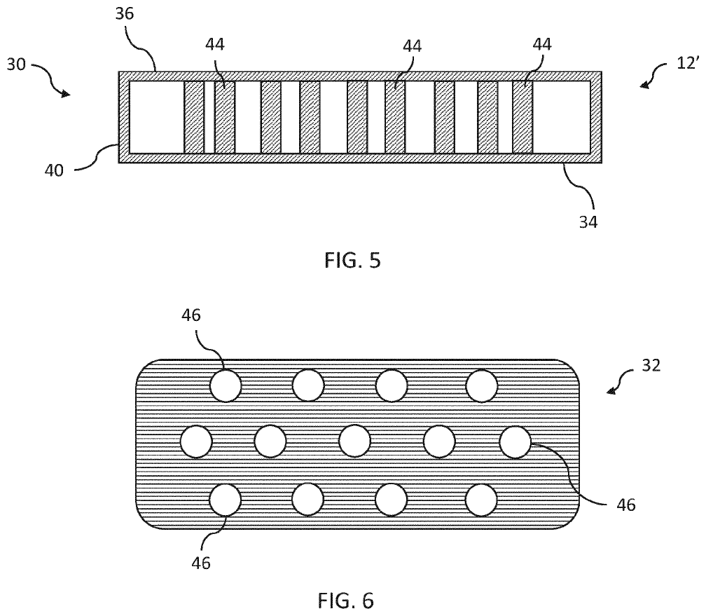

FIGS. 4 and 5 show schematic depictions of cross-sections of the rigid body 30. FIG. 4 shows a cross-section of the rigid body 30 on a plane which is parallel to and between the rear and gripping surfaces 34, 36. It can be seen from this figure that the rigid body 30 comprises a plurality of reinforcement elements, which in this embodiment comprise a plurality of columns 44. The plurality of columns 44 extend between and connect the rear and gripping surfaces 34, 36, increasing the rigidity of the rigid body 30. FIG. 4 illustrates the position of the plurality of apertures 42, formed within the gripping surface 36, relative to the position of the plurality of columns 44, with the plurality of apertures 42 being shown by dotted lines. It can be seen that the plurality of columns 44 are arranged such that they are not located underneath one of the plurality of apertures 42. FIG. 5 shows a cross-section of the finger assembly 12′ on a plane which is orthogonal to the gripping surface 36 (and also the rear surface 34), showing the connection of the gripping surface 36 to the rear surface 34 by the plurality of columns 44.

FIG. 6 shows a schematic depiction of the inflatable element 32 comprising a plurality of openings 46. The plurality of openings 46 are positioned such that they align with the plurality of columns 44 formed within the rigid body 30 when the inflatable element 32 is received within the rigid body 30. The material(s) which comprise the rigid body 30 have a first coefficient of friction and the material(s) which comprise the inflatable element 32 have a second coefficient of friction, wherein that the second coefficient of friction is greater than the first coefficient of friction.

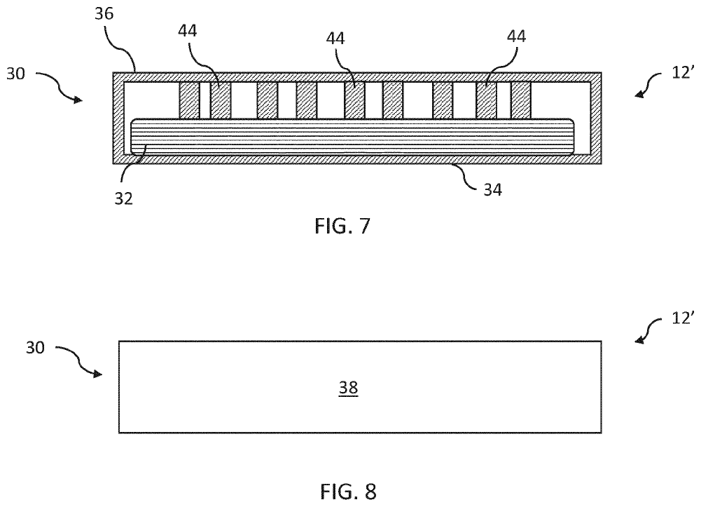

FIG. 7 shows the schematic depiction of the cross-sectional view of FIG. 5 in which the inflatable element 32 is received within the rigid body 30, such that each of the plurality of columns 44 is received within a respective opening of the plurality of openings 46 formed within the inflatable element 32. The size of the openings 46 is greater than the size of the columns 44 such that there it is possible for the inflatable element 32 to move relative to the plurality of columns 44. FIG. 7 shows the inflatable element 32 when it is in an uninflated or inactive state, and FIG. 8 shows the external side view of the finger assembly 12′ when the inflatable element 32 is in the uninflated state. In an alternative embodiment, the inflatable element 32 may substantially occupy the entire volume of the rigid body 30 in its uninflated state and comprise a plurality of extrusions positioned to coincide with the position of the plurality of opening 46. The extrusions are arranged such that, when the inflatable element 32 is uninflated, their end surfaces and the gripping surface 36 of the rigid body 30 substantially align in the same plane. This arrangement allows the extrusions to engage an object 16 with little deformation of the inflatable element 32, meaning that the inflatable element 32 can be pressurised less when compared to the current embodiment.

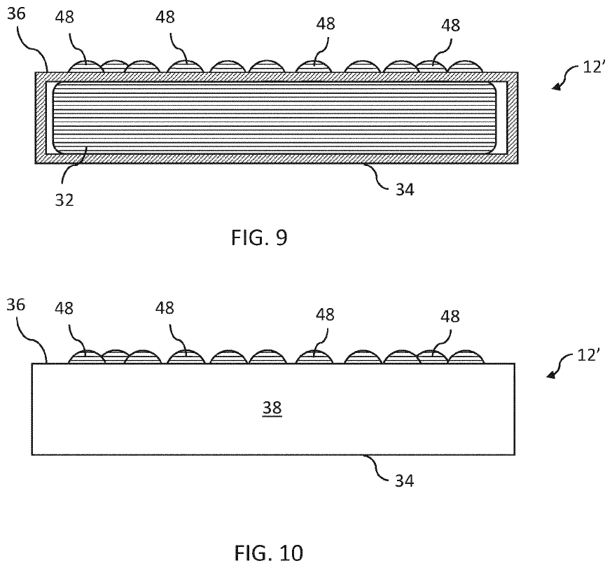

In use, the inflatable element 32 is inflated by a pressure regulating means 20′, according to an inflation control signal 24′, such that it expands and portions of the inflatable element 32 extend through the plurality of apertures 42 formed within the gripping surface 36, providing a number of contact points that conform to the object 16 and collectively define a reasonably large frictional contact area. FIG. 9 shows the cross-sectional view of the finger assembly 12′ when the inflatable element 32 is in an inflated state (or active state) inside the interior of the rigid body 30. When the inflatable element 32 is in this state, a plurality of protrusions 48 are formed, with the diameter and the location of the protrusions 48 being limited by the size and location of the apertures 42 formed within the gripping surface 36. FIG. 10 shows the exterior side view of the finger assembly 12′ when the inflatable element 32 is in the inflated state and shows the plurality of protrusions 48 of the inflatable element 32 above the gripping surface 36.

As mentioned above in connection with FIG. 1, the controller 14 is configured to output inflation control signals 24′ that are received by respective pressure regulating means 20′ for pressurising their associated inflatable elements 32 in dependence thereon. The inflation control signals 24′ are generated by the controller 14 according to a target pressure, defining a level to which an inflatable element 32 is to be pressurised. The target pressure is selected based on one or more characteristics of an object 16 being manipulated, such as its shape, weight, stiffness, fragility, etc., one or more of which may be determined based on the visual data input signal 23 from the optical sensor 26 and/or accessed by the electronic processor 21 from the memory device 28. By altering their pressure, the compliance of the inflatable elements 32, and the force exerted by them on the object 16 being manipulated, can be increased or decreased according to the chosen characteristics.

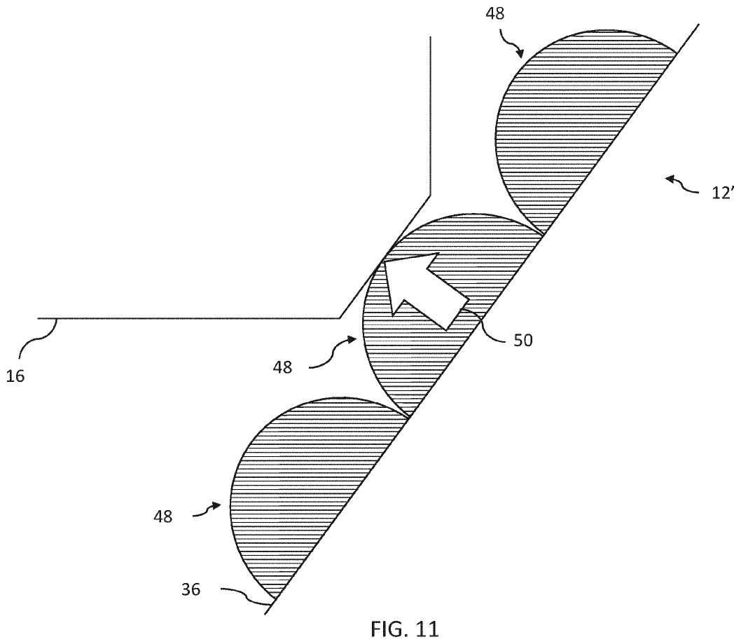

The target pressure can be within a range of 1 to 5 bar, and is varied within this range in order to change the compliance of the inflatable elements 32. That is, when the inflatable elements 32 are pressurised to 4 bar, for example, the protrusions 48 are substantially firm and able to resist any significant deformation when manipulating an object 16, as shown in FIG. 11. Such an arrangement might be use when the object 16 being manipulated has been determined to be heavy but with a high stiffness, such that it is able to withstand a normal force 50 applied by the protrusions 48 over a relatively small contact area, enabling the object 16 to be held with a high force.

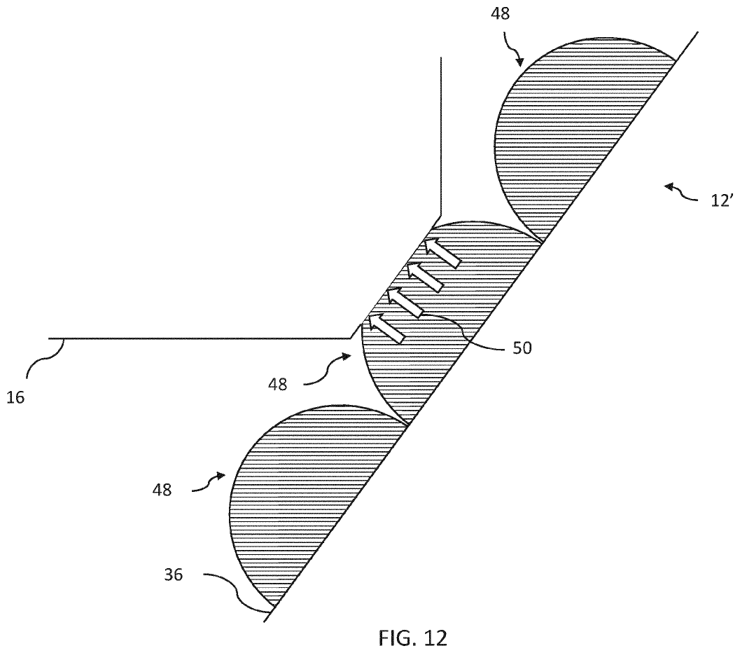

Conversely, when the inflatable elements 32 are pressurised to 1.5 bar, for example, the protrusions 48 are comparatively less firm and are therefore much more likely to deform according to the parts of the object 16 with which they are engaged, as shown in FIG. 12. In this arrangement, due to the greater compliance of the protrusion 48, a comparatively larger contact area is formed when compared to the arrangement shown in FIG. 11, increasing the frictional contact formed between the object 16 and the deformed protrusion 48, and decreasing the normal force 50 acting on the object 16. Such an arrangement may be desirable where the object 16 being manipulated is fragile and/or has a low stiffness.

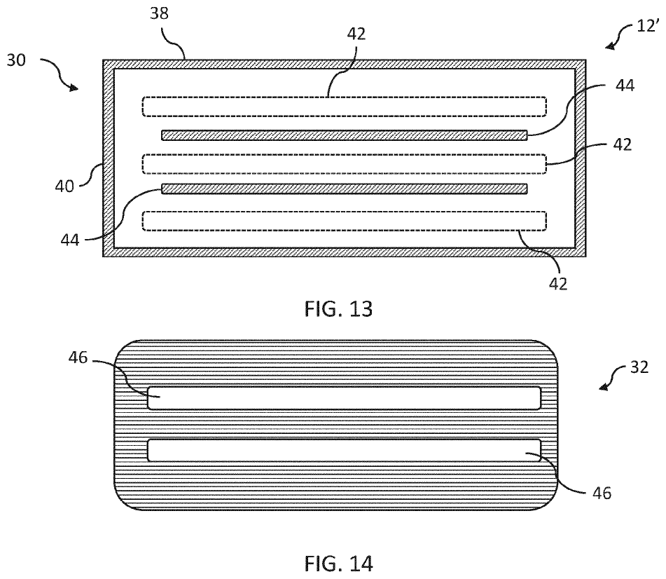

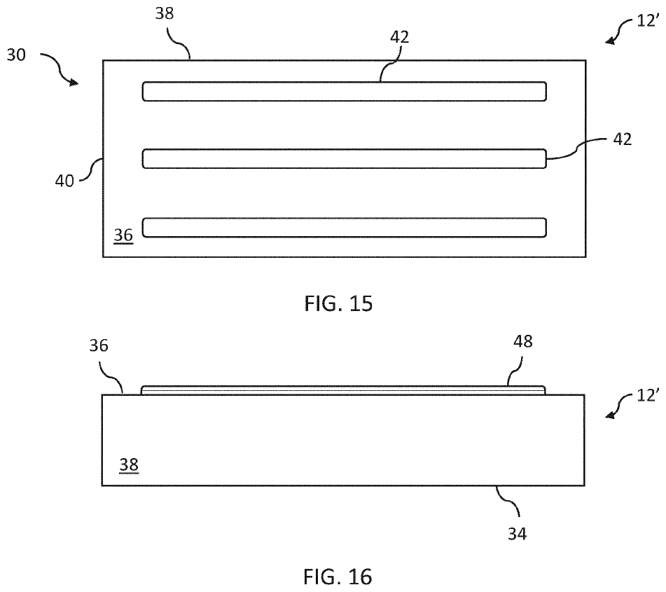

FIGS. 13 to 16 show schematic depictions of an alternative example of a finger assembly 12′ suitable for use in the manipulating apparatus 10. The finger assembly 12′ is as described above with reference to FIGS. 2 to 10 except that the gripping surface 36 of the rigid body 30 comprises three elongate apertures 42 and the reinforcement elements 44 comprise two elongate supports. Consequently, the inflatable element 32 comprises two elongate apertures 46 having a size and a location within the inflatable element 32 so as to allow the inflatable element 32 to be received within the rigid body 30. As described above, when the inflatable element 32 is in the uninflated state, the inflatable element 32 is completely received within the interior of the rigid body 30. When the inflatable element 32 is inflated, then portions of the inflatable element 32 may protrude through the elongate apertures 42 in the gripping surface 36, forming the plurality of protrusions 48. In this example, the protrusions 48 will comprise three linear protrusions extending along a portion of the length of the gripping surface 36.

The rigid body 30 may be formed by additive manufacturing, injection moulding or other conventional machining techniques. As mentioned above, the reinforcement elements 44 connect the rear and gripping surfaces 34, 36, increasing the rigidity of the rigid body 30 and reducing any deformation of the gripping surface 36 when the inflatable element 32 is inflated. The reinforcement elements 44 also act to restrict the movement of the inflatable element 32 when inflated. The rigid body 30 may be formed in two halves, which may be connected to each other to surround the inflatable element 32. The inflatable element 32 preferably comprises a single inlet through which it can be inflated, providing a fluid connection with the interior of the inflatable element 32 and a respective pressure line 27′. The inflatable element 32 may be formed from a flexible silicon material. The inflatable element 32 may be formed from two layers or a flexible silicon material which may then be securely connected together, for example by the use of an adhesive. The inlet may be formed from a rigid silicone material which can accept a pressurised air supply. The pressure regulating means 20′ may be configured to deflate the inflatable element 32 such that in the uninflated state a partial vacuum exists in the inflatable element 32, ensuring that all of the inflatable element 32 is retracted within the rigid body 30. A mesh may be applied to the face of the inflatable element 32 which forms the protrusions 48 when inflated. The mesh reinforces the inflatable element 32, making it more resilient. The patterning of the mesh may also lead to a further increase in the coefficient of friction for the protrusions 48 formed when the inflatable element 32 is inflated. The mesh also reduces the amount by which the inflatable element 32 can be inflated and allows for higher pressures to be applied that, in turn, allows for higher gripping forces, and less compliance. In alternative embodiments, the mesh might be embedded in the inflatable element 32.

When the finger assemblies 12′ are being manoeuvred so as to bring them into contact with an object 16 to be gripped, then it is preferable that the finger assemblies 12′ have low friction while they are positioned against the object 16. Subsequently, it is preferable that the finger assemblies 12′ have a high friction such that the object 16 can be gripped effectively and then manipulated, for example by picking up the object 16 and then moving it from a first location to a second location. It may be seen that the finger assemblies 12′ address this issue, as when the inflatable element 32 is in the uninflated state then the lower friction surface of the finger assemblies 12′ can be used to engage with an object 16. Once contact has been made, then the inflatable element 32 may be inflated, such that the higher friction inflated protrusions 48 grip the object 16 such that it can be manipulated. The higher friction of the inflated protrusions 48 enable a greater frictional force to be applied to the object 16. As mentioned above, the protrusions 48 may have a degree of pliability which may prevent the object 16 from being damaged by being gripped too tightly. Once the object 16 has been manipulated, for example the object 16 may be moved from a first location to a second location then the inflatable element 32 may be uninflated and the finger assemblies 12′ disengaged from the object 16.

The manipulating apparatus 10 may comprise contact sensors (not shown in FIG. 1) instead of or in addition to the optical sensor 26. The contact sensors detect when the gripping surface 36 of the first and second finger assemblies 12a, 12b are in contact with an object 16 and the output one or more signals to be received as input signals by the electronic processor 21 of the controller 14. The electronic processor 21 then outputs one or more inflation control signals 24′ to the pressure regulating means 20′ in dependence on the input signals to inflate the inflatable elements 32 when both the first and second finger assemblies 12a, 12b are in contact with an object 16. Alternatively or additionally, the manipulating apparatus 10 may comprise proximity sensors (not shown in FIG. 1) which detect when the gripping surfaces 36 of the first and second finger assemblies 12a, 12b are within specified distance of an object 16. The output signals of the proximity sensors are then received as input signals by the electronic processor 21 of the controller 14, which then outputs one or more inflation control signals 24′ based on the input signals to the pressure regulating means 20′ to inflate the inflatable elements 32 when the first and second finger assemblies 12a, 12b are sufficiently close to the object 16 to be gripped. Outputs from both a proximity and contact sensors may be used to determine the inflation of the inflatable elements 32.

Many modifications and variations can be made to the embodiments described above, without departing from the scope of the present invention. For example, the number, size and shape of the apertures 42 formed in the gripping surface 36 may be varied. For example, some embodiments of the finger assembly 12′ may comprise a single aperture 42 in the gripping surface 36, which is comparatively larger than those used in finger assemblies 12′ comprising multiple apertures 42. For some applications, it may be preferred that protrusions 48 are activated in different regions of the gripping surface 36. In such cases, the finger assembly 12′ may comprise a plurality of inflatable elements 32, each of which can be independently inflated or uninflated in a controllable manner.

The foregoing description has been presented for the purpose of illustration only and is not intended to be exhaustive or to limit the invention to the precise embodiments disclosed. It will be appreciated that modifications and variations can be made to the described embodiments without departing from the scope of the invention as defined in the appended claims.

1. A manipulating apparatus comprising:
a finger assembly including a rigid body having a surface configured to engage an object, the surface including one or more apertures; and, an inflatable element received within the rigid body, wherein when the inflatable element is inflated, regions of the inflatable element form one or more protrusions by protruding through the one or more apertures;
a controller configured to output an inflation control signal for pressurising the inflatable element according a target pressure, the target pressure being dependent on a characteristic of the object; and
a pressure regulating means configured to receive the inflation control signal and pressurise the inflatable element in dependence on the inflation control signal.

2. A manipulating apparatus according to claim 1, wherein the controller is configured to vary pressure within the inflatable element within a range of 1 to 5 bar.

3. A manipulating apparatus according to claim 1, wherein the surface configured to engage an object has a first coefficient of friction and a surface of the inflatable element has a second coefficient of friction, and wherein the first coefficient of friction is less than the second coefficient of friction.

4. A manipulating apparatus according to claim 1, wherein a mesh is formed on the surface of the inflatable element.

5. A manipulating apparatus according claim 1, wherein the rigid body comprises:
a rear surface which is in opposition to the surface configured to engage an object, and wherein the finger assembly includes one or more reinforcement elements extending between the rear surface and the surface configured to engage an object.

6. A manipulating apparatus according to claim 1, wherein at least one of the one or more apertures is substantially circular.

7. A manipulating apparatus according to claim 1, wherein at least one of the one or more apertures is substantially elongate.

8. A manipulating apparatus according to claim 1, wherein the finger assembly comprises:
an actuator, and the controller is configured to output an actuation control signal for causing the finger assembly to move, and wherein the actuator is configured to receive the actuation control signal and move the finger assembly in dependence on the actuation control signal.

9. A manipulating apparatus according to claim 1, wherein the controller is configured to cause the inflatable element to inflate in accordance with a location of the finger assembly relative to an object.

10. A manipulating apparatus according to claim 9, wherein the controller is configured to cause the inflatable element to inflate when the finger assembly is moved into proximity with an object.

11. A manipulating apparatus according to claim 9, wherein the controller is configured to cause the inflatable element to inflate when the finger assembly is moved into contact with an object.

12. A method of manipulating an object using a manipulating apparatus, the manipulating apparatus including:
a first finger assembly, and a second finger assembly, each finger assembly including a rigid body having a surface configured to engage an object, the surface including one or more apertures; and, an inflatable element received within the rigid body, wherein when the inflatable element is inflated, regions of the inflatable element form one or more protrusions by protruding through the one or more apertures;
a controller configured to output an inflation control signal for pressurising the inflatable element according a target pressure, the target pressure being dependent on a characteristic of the object; and
a pressure regulating means configured to receive the inflation control signal and pressurise the inflatable element in dependence on the inflation control signal, the method comprising of:
a) moving a first finger assembly relative to the second finger assembly to engage the object;
b) inflating inflatable elements of the first and second finger assemblies;
c) determine a target pressure within the inflatable elements according to a characteristic of the object;
d) varying pressure within the inflatable elements according to the target pressure;
e) engaging the object with the first and second finger assemblies; and
f) manipulating the object.

13. A method according to claim 12, comprising:
g) deflating the inflatable elements of the first and second finger assemblies; and
h) disengaging the first and second finger assemblies from the object.

14. A manipulating apparatus according to claim 2, wherein the surface configured to engage an object has a first coefficient of friction and a surface of the inflatable element has a second coefficient of friction, and wherein the first coefficient of friction is less than the second coefficient of friction.

15. A manipulating apparatus according to claim 15, wherein a mesh is formed on the surface of the inflatable element.

16. A manipulating apparatus according to claim 16, wherein the rigid body comprises:
a rear surface which is in opposition to the surface configured to engage an object, and wherein the finger assembly includes one or more reinforcement elements extending between the rear surface and the surface configured to engage an object.

17. A manipulating apparatus according to claim 17, wherein at least one of the one or more apertures is substantially circular.

18. A manipulating apparatus according to claim 18, wherein at least one of the one or more apertures is substantially elongate.

19. A manipulating apparatus according to claim 19, wherein the finger assembly comprises:
an actuator, and the controller is configured to output an actuation control signal for causing the finger assembly to move, and wherein the actuator is configured to receive the actuation control signal and move the finger assembly in dependence on the actuation control signal.

20. A manipulating apparatus according to claim 1, wherein the controller is configured to cause the inflatable element to inflate in accordance with a location of the finger assembly relative to an object.
